(19) United States
(12) Patent Application Publication
(10) Pub. No.: US 2026/0310217 A1
(43) Pub. Date: Oct. 8, 2026

(54) OBSTACLE-AVOIDANCE UNMANNED AERIAL VEHICLE-BASED DATA COLLECTION METHOD FOR MOBILE NODES IN FOREST FIRES

(71) Applicant: CHONGQING UNIVERSITY OF POSTS AND TELECOMMUNICATIONS, Chongqing (CN)

(72) Inventors: YONGJU XIAN, Chongqing (CN); ZHOU WANG, Chongqing (CN); YUN LI, Chongqing (CN); GUANGFU WU, Chongqing (CN)

(21) Appl. No.: 19/679,912

(22) Filed: May 18, 2026

Related U.S. Application Data
(63) Continuation of application No. PCT/CN2026/075078, filed on Jan. 27, 2026.

(30) Foreign Application Priority Data
Feb. 14, 2025 (CN) 202510166088.2

(51) Int. Cl. G05D 1/622; G05B 13/02; G05B 13/04; G05D 101/15; G05D 105/55; G05D 107/20; G05D 109/10; G05D 109/25

(52) U.S. Cl. CPC G05D 1/622; G05B 13/027; G05B 13/04; G05D 2101/15; G05D 2105/55; G05D 2107/22; G05D 2109/10; G05D 2109/254

(57) ABSTRACT

An obstacle-avoidance unmanned aerial vehicle (UAV)-based data collection method for mobile nodes in forest fires includes: acquiring data of ground mobile nodes and data of UAV nodes, and establishing a system model according to node data; constructing an optimization problem according to the system model; solving the optimization problem by adopting a deep reinforcement learning model; obtaining an agent for planning an obstacle-avoidance path according to a result of the solving; and deploying the agent on a UAV. The present disclosure quantitatively analyzes a unit data value of each mobile node according to a forest fire spread situation, realizing more efficient data collection; and solves a dynamic obstacle avoidance problem with UAVs by establishing a safety distance constraint between UAVs.

### CROSS-REFERENCE TO RELATED APPLICATIONS

This application is a continuation of PCT/CN2026/075078, filed on Jan. 27, 2026 and claims priority of Chinese Patent Application No. 202510166088.2, filed on Feb. 14, 2025, the entire contents of which are incorporated herein by reference.

### TECHNICAL FIELD

The present disclosure relates to the fields of unmanned aerial vehicles (UAVs) and Internet of things (IoT) technology, and specifically to an obstacle-avoidance UAV-based data collection method for mobile nodes in forest fires.

### BACKGROUND

The safety of firefighters and real-time changes in the spread of the fire in a forest fire scene are extremely important. Traditional data collection methods, such as wired network connections, multi-hop transmission of wireless network nodes, or reliance on fixed base stations, have many limitations. Wired connections have high installation costs and cannot adapt to the dynamic changes of mobile nodes. Multi-hop transmission of wireless network nodes consumes a large amount of energy, and meanwhile, the mobility of nodes causes frequent changes in network topology. Fixed base stations are limited by coverage area and cannot achieve comprehensive coverage in remote or complex terrain. Furthermore, when mobile nodes move frequently, traditional methods cannot guarantee stable data transmission, leading to data loss or delay.

The rapid development of crowdsensing and the Internet of Things (IoT) makes it possible to deploy a large number of mobile sensors in a fire scene. These data collection nodes, benefiting from a certain degree of mobility, can survive for a long time in the fire scene, continuously collect complete data of continuously changing conditions, and provide a large amount of environmental information and the firefighters' vital signs, thus playing an irreplaceable and vital role in ensuring personnel safety. The use of unmanned aerial vehicles (UAVs) to assist in data collection tasks further solves the problems of data collection and transmission, avoiding the energy consumption and random performance degradation caused by traditional multi-hop transmission.

However, the mobility of the nodes makes the relative positions of different nodes and the fire scene change during data collection tasks, and value of the data also varies from the changes. Concurrently, mobile aerial nodes and other non-cooperative UAVs introduce dynamic obstacles into the flight environment.

The differences in data value from different nodes and the problem of dynamic obstacle avoidance for UAVs bring more challenges to UAV-assisted data collection tasks.

### SUMMARY

In view of this, the present disclosure provides an obstacle-avoidance unmanned aerial vehicle (UAV)-based data collection method for mobile nodes in forest fires, to solve the above problems, including the steps 1-4.

In step 1, data of ground mobile nodes and data of UAV nodes are acquired, and a system model is established according to the data of the ground mobile nodes and the data of the UAV nodes.

In step 2, an optimization problem is constructed according to the system model.

In step 3, the optimization problem is solved by adopting a deep reinforcement learning model, and an agent for planning an obstacle-avoidance path is obtained according to a result of the solving.

In step 4, the agent is deployed to a UAV, the UAV acquires real-time environmental data, the agent gives an action instruction for a next moment of the UAV according to the real-time environmental data, and the UAV executes a data collection task according to the action instruction.

The present disclosure has the following benefits: by establishing the mobile node model, the quantitative analysis of unit data values of the mobile nodes is performed according to status of forest fire spread, to implement more efficient data collection, and cover a larger range of data sources in a short time to significantly improve data integrity and provide data fundamentals for subsequent in-depth analysis and decision-making; and by establishing the safe distance constraints between the UAVs according to a state-vector relationship between a task UAV and a node UAV or a non-cooperative UAV, and the problem of dynamic obstacle avoidance of the UAVs is solved.

### BRIEF DESCRIPTION OF THE DRAWINGS

FIG. 1 is a flowchart of an obstacle-avoidance unmanned aerial vehicle (UAV)-based data collection method for mobile nodes in forest fires according to the present disclosure.

FIG. 2 is a diagram of a system architecture of the obstacle-avoidance UAV-based data collection method according to the present disclosure.

FIG. 3 shows a comparison diagram of convergence of reward values of an agent during training under different algorithms according to an embodiment of the present disclosure.

FIG. 4 shows a comparison diagram of total data collection rates of a task UAV under different algorithms according to an embodiment of the present disclosure.

FIG. 5 shows a comparison diagram of data collection rates of the task UAV for aerial nodes under different algorithms according to an embodiment of the present disclosure.

FIG. 6 shows a comparison diagram of data collection rates of the task UAV for ground mobile nodes under different algorithms according to an embodiment of the present disclosure.

FIG. 7 shows a comparison diagram of data collection rates of the task UAV for high-value nodes under different algorithms according to an embodiment of the present disclosure.

FIG. 8 shows a comparison diagram of success rates of safety trajectory planning of the task UAV under different algorithms according to an embodiment of the present disclosure.

### DETAILED DESCRIPTION

To more clearly introduce purpose, technical solutions, features and advantages of the present disclosure, the present disclosure will be further described below with reference to drawings and embodiments.

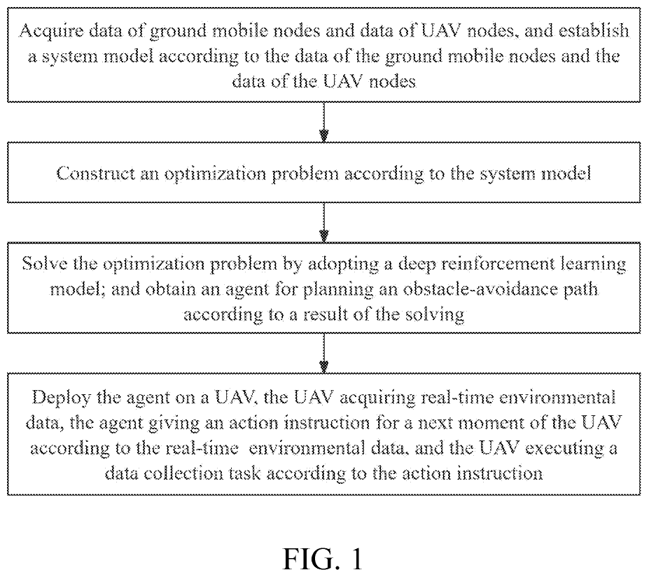

The embodiment includes an obstacle-avoidance unmanned aerial vehicle (UAV)-based data collection method for mobile nodes in forest fires, the flowchart being shown in FIG. 1, including the steps S1-S4.

In S1, data of ground mobile nodes and data of UAV nodes are acquired, and a system model is established according to the data of the ground mobile nodes and the data of the UAV nodes.

Further, the system model includes a system architecture, a fire area model, a mobile node model and a data collection task model.

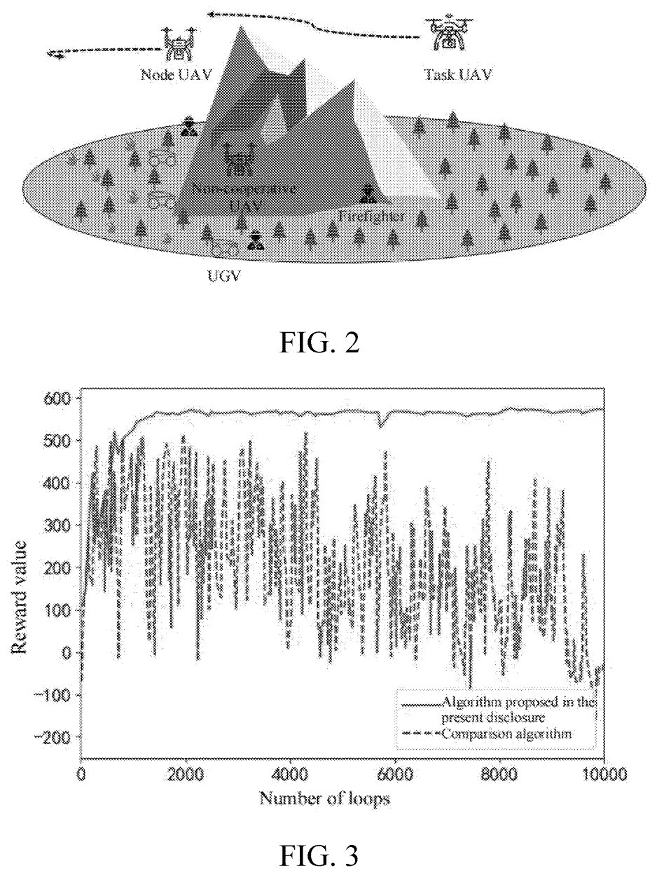

Specifically, descriptions of the system architecture are as follows: as shown in FIG. 2, a task UAV maintains flight at a safe altitude, a spatial position of the task UAV is expressed as q[n]=(x[n], y[n], hᵤ), where hᵤ is a flight altitude of the UAV. A projected coordinate of the UAV in a flight plane is qᵤ[n]=(x[n], y[n]); a speed over ground of the UAV is v[n]=(vₓ[n], v_{y}[n]); and a course of the UAV is q[n]∈[−π, π]. Further, a state-vector of the task UAV is Sᵤ[n]=(q[n], v[n], q[n]).

Further, the system includes K wireless sensor nodes, which are divided into fast-moving aerial nodes and slow-moving ground nodes, the fast-moving aerial nodes include K₁ UAV nodes performing data collection tasks in a fire scene, and the slow-moving ground nodes include K₂ unmanned ground vehicles (UGVs) and K₃ firefighters in the scene, K=K₁+K₂+K₃. The number of UAVs performing other tasks is recorded as L, no direct scheduling communication between a UAV performing other tasks and a task UAV in the present system, so the UAV also brings obstacles to flight of the task UAV. When these UAVs approach the task UAV, basic information of these non-cooperative UAVs is acquired by the task UAV through an airborne sensor, a state-vector of other non-cooperative UAVs in the fire scene is Sᵢ[n]=(qᵢ[n], vᵢ[n], φᵢ[n]), where qᵢ[n]=(xᵢ, yᵢ) represents a location of the non-cooperative UAV, vᵢ[n] represents a speed of the non-cooperative UAV, and φₗ[n] represents a course of the non-cooperative UAV.

Specifically, descriptions of the fire area model are as follows: in the forest fire scene, wind force can influence a process of forest fire spread and concurrently flight speed of the UAV. The environmental wind speed v_{w}[n] represents v_{w}[n]=v̅_{w}[n]+λv_{w}[n], where v̅_{w}[n] represents data of a wind speed sensor of the UAV, n represents an n-th time slot obtained by evenly dividing a maximum task time, λv_{w}[n] represents a degree of uncertainty in wind speed, which is determined by the difference between meteorological data and on-site wind speed, the greater the difference is, that is, the greater the uncertainty is, the faster the wind changes, and the greater the maximum uncertainty of the wind speed λv_{w}^{max} is. Further, the flight speed of the UAV is v[n]=vᵤ[n]+λv_{w}[n], where vᵤ[n] is a speed over ground of the UAV in a windless environment, λ is a discount factor affected by the wind speed, vᵤ[n] is speed over ground of the UAV in a windless environment, and λ is a discount factor affected by the wind speed, with an optimal range of 0.005-0.01, preferably 0.01 in this embodiment. Limited by inherent performance of the UAV, the following constraints apply:

$${‖ {v}_{u} [ n ] ‖}_{2} \leq {v}_{max} , ∀ n ∈ N and \vert φ [ n ] - φ [ n - 1 ] \vert \leq {φ}_{max} , ∀ n ∈ N .$$

Further, effects of mountain and vegetation on terrain represent

$$z ( x , y ) = {\sum }_{i} {h}_{i} {e}^{- {( \frac{x - {x}_{i}}{{x}_{si}} )}^{2} - {( \frac{y - {y}_{i}}{{y}_{si}} )}^{2}} ,$$

where (x, y) represents an x-y plane coordinate, z is an altitude of the location, hᵢ represents an overall height of an i-th mountain, and xᵢ and yᵢ control slopes of the mountain along an x-axis and a y-axis, respectively.

Furthermore, known terrain obstacles and unknown environmental obstacles are to be avoided by the UAV during the flight, various obstacles in an area of the UAV flight altitude plane represent set D={D₁, D₂, . . . . D}, where Dⱼ represents a j-th obstacle, Dⱼ is a set of z(x, y)>hᵤ, i.e. a set of points where an altitude is higher than the flight altitude of the UAV; and an obstacle avoidance constraint of the UAV is qᵤ[n]∉Dⱼ, ∀ⱼ∈{1, 2, . . . , J}, ∀n∈N. Environmental information is detected by the UAV through an airborne distance sensor, and an acquired surrounding environmental information vector is Sₒ[n]=(d₁[n], d₂[n], . . . , d₈[n]), where dᵢ[n], i∈{1, 2, . . . , 8} represents a distance between the UAV and the obstacle detected by a sensor in a certain direction, and the sensor has a maximum detection range limitation.

Further, the process of forest fire spread is described by adopting a cellular automaton. A task area is divided by the cellular automaton into closely adjacent square grids, each grid is a cell, the property of the cell is determined by inner factors of the cell such as spatial terrain, vegetation, meteorological conditions, moment of ignition, burning state, etc. State of the cell can be divided into five stages: unburned, burning, completely burned, unextinguished, and completely extinguished, which are respectively represented by F₀, F₁, F₂, F₃ and F₄, and a formula of initial rate of forest fire spread is expressed by:

$${R}_{F 0} = a * {T}_{F} + b * {V}_{F} + c * ( 100 - {V}_{F} ) + d$$

where T_{F} is a temperature, V_{F} is a wind scale, Hp is a relative humidity, a, b, c, and d are empirical parameters, and optimal values of which are 0.03, 0.05, 0.01 and −0.3. Further considering that the effects of types of combustible materials, terrain slope and wind vector on initial spread rate, the obtained and revised rate of forest fire spread is R=R_{F0}*K_{f}*Kₛ*K_{w}, where R is a revised rate of forest fire spread; K_{f} is a correction coefficient of types of combustible materials, Kₛ is a correction coefficient of terrain slope, Kₛ describes an effect of different slopes on the rate of forest fire spread; K_{w} is a correction coefficient of the wind vector, and K_{w} describes an effect of different wind scales and wind direction conditions on the rate of the spread.

Further, a coordinate index of each cell is defined as u and v, the rate of forest fire spread of a cell (u, v) is defined as

$${R}_{u , v}^{t} ,$$

and a distance between the cell and an adjacent cell is defined as a side length of the cell L. State transition rules of the cell are: when an unburned cell is ignited, F₀ is turned into F₁; F₁ is transitioned to F₂ after internal burning time

$$Δ n = \frac{L}{{R}_{IN}} ,$$

F₀ parallel to fire line is ignited within Δn, where R_{IN} is a rate of internal forest fire spread of the cell, and L represents a side length of the cell; surrounding all of F₀ is ignited by F₂, when there is no F₀ around the cell in an F₂ state, the cell is transitioned to F₃, and the transition takes. Δn; and the cell in an F₃ state is transitioned to an F₄ state after Δn. set [symbol] _{f}[n] represents an area spread by forest fire, which consists of the cells in the F₁ state and subsequent states, if a coordinate qₖ of a node k is in the [symbol] _{f}[n], the node k is a failure node.

Specifically, descriptions of the mobile node model are as follows: because performed tasks are different, different mobile nodes are equipped with different mobile characteristics. Moving range of the firefighters and the UGV is relatively small as ground nodes during data collection task time of the UAV, the UGV approaches the fire scene, but the firefighters keep a distance with the fire scene. The UAV has relatively large range of activity as an aerial node, according to differences of specific tasks, a node UAV maybe have different speeds and directions.

Further, a spatial position of the ground node is

$${q}_{k}^{g} [ n ] = ( {x}_{k} [ n ] , {y}_{k} [ n ] , {h}_{k} [ n ] )$$

(including K₂ UGV nodes and K₃ firefighter nodes), a moving speed of the ground node is regarded as low-speed linear motion of short distance because it is lower than the flight speed of the task UAV; and a speed of the ground node is

$${v}_{k}^{g} [ n ] = ( {v}_{xk} [ n ] , {v}_{yk} [ n ] ) ,$$

and its direction is

$${φ}_{k}^{g} [ n ] .$$

A spatial position of a K₁ node UAV is

$${q}_{k}^{a} [ n ] = ( {x}_{k} [ n ] , {v}_{k} [ n ] , {h}_{k} [ n ] ) ,$$

with a speed of

$${v}_{k}^{a} [ n ] = ( {v}_{xk} [ n ] , {v}_{yk} [ n ] ) ,$$

and course of

$${φ}_{k}^{a} [ n ] ;$$

the node UAV for monitoring the fire scene moves along with changes of the fire line, i.e., a speed of the node UAV based on speed of forest fire spread R in the fire area model changes according to task requirements; and the node UAV for monitoring a key area cruises above the area along a fixed trajectory, depending on the size of the area, cruising trajectory of the node UAV differs.

Further, in a time slot n, for a certain node, the closest main fire points A and B, locations of which are (xₐ, yₐ) and (x_{b}, y_{b}) respectively, and y_{b}>yₐ, and an edge direction of the fire line consist of A and B is φ_{AB}[n]=arctan ((y_{b}−yₐ)/(x_{b}−xₐ)). An indicator of a relative position change between the node and the forest fire is

$${φ}_{k}^{f} [ n ] = {φ}_{k} [ n ] - {φ}_{AB} [ n ] .$$

Furthermore, a unit data value of a node pₖ[n] is defined as follows:

$${p}_{k} [ n ] = β ( 1 - {\vert {φ}_{k}^{f} [ n ] - \frac{π}{2} \vert}^{2} ) + γ$$

where pₖ[n] represents a unit data value from a node k in an n-th time slot, β represents a node motion trend attention coefficient, with a range of 1-2, preferably 1 in the embodiment, and y represents a firefighter life safety coefficient, γ is 0 when the node k is a UAV node or UGV node, and 2 when the node k is a firefighter node.

Further, an operational height may be adjusted by the node UAV at any time according to requirements of the task, when the flight altitude of the node UAV approaches hᵤ, a new security threat to flight of the task UAV is posed by the node UAV, concurrently considering that there are still L non-cooperative UAVs in the same space, and a safe distance constraint between the task UAV and other UAVs dᵤₖ[n] is expressed by:

$${d}_{uk} [ n ] = {( x [ n ] - {x}_{k} [ n ] )}^{2} + {( y [ n ] - {y}_{k} [ n ] )}^{2} + {( {h}_{u} - {h}_{k} [ n ] )}^{2} \geq {D}_{u} ,$$

$$∀ n ∈ N , ∀ k ∈ {K}_{1} + L$$

where a calculation formula of Du is expressed by:

$${D}_{u} = {( \frac{{l}_{mm} + {l}_{om}}{2} + {d}_{safe} )}^{2}$$

where lₘₘ represents a maximum value of size of the task UAV, lₒₘ represents a maximum value of size of other UAV, and d_{safe} represents a safety redundancy distance, preferably 1.5 m.

Specifically, descriptions of the data collection task model are as follows: the data collection task model is used for establishing a communication constraint, and the communication constraint includes a scheduling constraint and a data transmission constraint. A channel between the UAV and the ground mobile node is mainly affected by vegetation in the forest fire, and a formula of a path loss model PLₖ[n] adopted by the present disclosure is:

$${PL}_{k} [ n ] = 20 {log}_{10} ( {f}_{c} ) + 10 {n}_{1} {log}_{10} ( {θ}_{k} [ n ] ) + 10 {n}_{2} {log}_{10} ( {d}_{k} [ n ] ) + {X}_{σ}$$

$${d}_{k} [ n ] = \sqrt{{( x [ n ] - {x}_{k} [ n ] )}^{2} + {( y [ n ] - {y}_{k} [ n ] )}^{2} + {( {h}_{u} - {h}_{k} [ n ] )}^{2}}$$

where f_{c} represents a carrier frequency, and θₖ represents an elevation angle of a UAV relative to the ground node, χ_{σ} represents a shadowing fade and accords with gaussian distribution; dₖ[n] represents a distance between UAV and the node k; (x[n], y[n], hᵤ) represents a spatial position of the UAV; (xₖ[n], yₖ[n], hₖ[n]) is a location of a k-th node; and n₁ and n₂ are an impact factor of the elevation angle and a path loss exponent, respectively.

Further, node transmission power is defined as po, noise power of a UAV receiving end is defined as pₙ, and a signal-to-noise ratio of the UAV receiving end is defined as γₖ[n]:

$${γ}_{k} [ n ] = {p}_{0} - {PL}_{k} [ n ] - {p}_{n} .$$

Further, a communication speed between the UAV and the ground mobile node is

$${R}_{k}^{g} [ n ] ;$$

$${R}_{k}^{g} [ n ] = B {log}_{2} ( 1 + 1 {0}^{\frac{{γ}_{k} [ n ]}{10}} )$$

where B represents a channel bandwidth.

A communication channel between the task UAV and the UAV node can be regarded as line-of-sight (LoS) propagation, a channel gain is

$${g}_{los} = \frac{{β}_{0}}{{d}_{k}^{2} [ n ]} ,$$

a communication speed between the task UAV and the node UAV based on propagation loss of free space is

$${R}_{k}^{a} [ n ] = {Blog}_{2} ( 1 + \frac{{p}_{0} {g}_{los}}{{p}_{n}} ) ,$$

and β₀ is a channel gain per unit distance.

Further, to support stable data stream transmission, it is necessary to start the data collection task when receiving a signal-to-noise ratio of UAV γₖ[n]≥γ₀, where γ₀ is an artificially set signal-to-noise ratio threshold, with an optimal range from −5 dB to −10 dB, preferably −5 dB in the embodiment, the task UAV collects data from no more than one node every time

$${s}_{k}^{s} [ n ] ∈ \{ 0 , 1 \}$$

is used for representing connection between the UAV and a k-th node, and the scheduling constraint is expressed by

$${\sum }_{k = 1}^{K} {s}_{k}^{s} [ n ] \leq 1 , ∀ n ∈ N .$$

Further, nodes with good and stable communication channels are preferentially selected by the UAV for data transmission task, and a formula of scheduling policy is expressed by:

$${s}_{k}^{s} [ n ] = \{ \begin{matrix}1 , & if k = arg {max}_{{k}^{′} ∈ \{ active nodes \}} {γ}_{k} [ n ] \\ 0 , & otherwise\end{matrix}$$

where active nodes are defined as nodes with a signal-to-noise ratio of γₖ[n]≥γ₀, while otherwise are defined as nodes with a signal-to-noise ratio of lower than a threshold γ₀ and failure nodes.

Further, a data transmission constraint obtained that data volume collected from the node k by the UAV is expressed by

$${Q}_{k} = {\sum }_{n = 1}^{N} {R}_{k} [ n ] δ [ n ] {s}_{k}^{s} [ n ] \leq {Q}_{max} ,$$

where

$${Q}_{k}^{L} [ n ]$$

represents a total amount of data collected from the node k in the time slot n, the superscript L is used for distinguishing

$${Q}_{k}^{L} [ n ]$$

from Qₖ, the total amount of data that can be collected by the UAV is expressed by

$$Q = {Σ}_{k = 1}^{K} {Σ}_{n = 1}^{N} {R}_{k} [ n ] δ [ n ] {s}_{k}^{s} [ n ]$$

in a data collection process of all nodes, and the maximum task time is uniformly discretized into N time slots, such that a position of the UAV can be approximately regarded as unchanged in each of time slots, a length of slot in the n-th time slot is δ[n]=Tₘₐₓ/N, and the number of time slot N in the embodiment is preferably 300.

In S2, an optimization problem is constructed according to the system model.

Specifically, the optimization problem is expressed by:

$${argmax}_{[ \{ qn ] \}} {\sum }_{k = 1}^{K} {\sum }_{n = 1}^{N} {p}_{k} [ n ] {R}_{k} [ n ] δ [ n ] {s}_{k}^{s} [ n ]$$

$$subject to$$

$$C 1 : {‖ {v}_{u} [ n ] ‖}_{2} \leq {v}_{max} , ∀ n ∈ N$$

$$C 2 \text{:} \vert φ [ n ] - φ [ n - 1 ] \vert \leq {φ}_{max} , ∀ n ∈ N$$

$$C 3 \text{:} {‖ Δ {v}_{w} [ n ] ‖}_{2} \leq Δ {v}_{w}^{max} , ∀ n ∈ N$$

$$C 4 : {q}_{u} [ n ] ∉ {D}_{j} , ∀ j ∈ \{ 1 , 2 , … , J \} , ∀ n ∈ N$$

$$C 5 : {d}_{u k} [ n ] = {( x [ n ] - {x}_{k} [ n ] )}^{2} + {( y [ n ] - {y}_{k} [ n ] )}^{2} + {( {h}_{u} - {h}_{k} [ n ] )}^{2} \geq {D}_{u} , ∀ n ∈ N , ∀ k ∈ {K}_{1} + L$$

$$C 6 : {\sum }_{k = 1}^{K} {s}_{k}^{s} [ n ] \leq 1 , ∀ n ∈ N$$

$$C 7 : {Q}_{k} = {\sum }_{n = 1}^{N} {R}_{k} [ n ] δ [ n ] {s}_{k}^{s} [ n ] \leq {Q}_{max} , ∀ k ∈ K$$

$$C 8 : T \leq {T}_{max}$$

where C1 is a UAV flight speed performance constraint, C2 is a UAV steering performance constraint, C3 is an environmental wind uncertainty constraint, C4 is an obstacle avoidance constraint, C5 is a safety distance constraint between UAVs, C6 is a scheduling constraint, C7 is a data transmission constraint, and C8 is a task time constraint.

In S3, a deep reinforcement learning model is used to solve the optimization problem, an agent for planning an obstacle-avoidance path is obtained according to a result of the solving.

Further, Markov decision process is used for expressing sequential decision problems, i.e. mathematical expression, which is represented by using a tuple < [symbol] >, with the specific meaning of the decision process as follows:
where [symbol] represents a state space, an environmental information vector S[n]=(Sᵤ[n], Sₒ[n], Sₛ[n], S_{c}[n], Sₜ), where Sᵤ[n] is a state information vector of the UAV, Sᵤ[n]=(q[n], v[n], φ[n]), where v[n] represents a flight speed of the UAV, with a formula of v[n]=vᵤ[n]+λv_{w}[n], where vᵤ[n] is a speed over ground of the UAV in a windless environment, and λ is a discount factor affected by the wind speed, with an optimal range of 0.005-0.01, preferably 0.01 in the embodiment; Sₒ[n]=(d₁[n], d₂[n], . . . , d₈[n]), where dᵢ[n], i∈{1, 2, . . . , 8} represents a distance between the UAV and the obstacle detected by the sensor in a certain direction, the sensor has a maximum detection range limitation, and Sₒ[n] represents an environmental information vector obtained that the UAV detects environmental information through the airborne distance sensor; Sₛ[n] is a global node information vector;

$${S}_{s} [ n ] = ( {s}_{k} [ n ] ) for k ∈ K , {s}_{k} [ n ] = ( {q}_{k} [ n ] , {s}_{k}^{s} [ n ] , {γ}_{k} [ n ] ) ,$$

where sₖ[n] represents an information vector of a single node k; s_{c}[n] is an information vector of the non-cooperative UAV, because input of neural network is the environmental information vector, and a dimension of the environmental information vector can be influenced by dimensional changes of sc [n], the dimension is limited to C, and S_{c}[n]=(S₁[n]), 1∈C, C<L; and when the number of the non-cooperative UAVs near the task UAV is less than C, 0 is used for filling in a corresponding input dimension; and Sₜ is time consumed for task execution.

Moreover, [symbol] represents an action, actions of the agent are limited by mechanical property of the UAV, only taking an executable action pair [v_{c}, φ_{c}] that is sampled from the set of legitimate actions; and safety rules are defined, when next action of the UAV can fly towards the obstacle, and the action is canceled and punishment is given.

[symbol] represents state transition in the whole system.

[symbol] represents a reward function set according to the optimization problem.

γ represents a current value discount of future rewards, with a value range of [0,1].

A double deep Q-network (DDQN) reinforcement learning model is adopted to solve the optimization problem, during the solving process, the settings are as follows:

A data collection reward is

$${R}_{d c} = {α}_{1} * {Σ}_{k = 1}^{K} {p}_{k} [ n ] ( {Q}_{k}^{L} [ n + 1 ] - {Q}_{k}^{L} [ n ] ) ,$$

where α₁ represents a data collection amount scaling factor, which is used for reducing the data collection amount to an appropriate range, α₁ is preferably 10⁻⁶ in the embodiment, pₖ[n] represents a unit data value of the k-th node, and

$${Q}_{k}^{L} [ n + 1 ]$$

represents a total data collection amount collected from the node k in an n+1 time slot.

A remaining task time reward is

$${R}_{tk} = {α}_{2} ( T - {Σ}_{n = 0}^{N} δ [ n ] ) ,$$

where α₂ represents a time quantity scaling factor, which is used for reducing a time quantity to an appropriate range, and α₂ is preferably 0.1 in the embodiment.

A dynamic obstacle avoidance penalty is

$${R}_{u o} = {α}_{3} ( \frac{d}{{D}_{s}} - 1 ) ,$$

d=min(d₁[n], d₂[n], . . . , d₈[n]), where α₃ represents an obstacle avoidance penalty coefficient, which is used for amplifying a minimum detection range to an appropriate range, preferably 10 in the embodiment, d represents a minimum value of distances between the UAV and the obstacle detected by the sensor in all directions, and Dₛ represents a maximum detection range of a UAV distance sensor.

For known obstacles, a static obstacle collision penalty is

$${R}_{so} = \{ \begin{matrix}- {α}_{4} , ( x [ n ] , y [ n ] ) ∈ {D}_{j} \\ 0 , otherwise\end{matrix} ,$$

where α₄ represents a collision penalty value, preferably 1 in the embodiment.

For a flight environment of multiple UAVs, a safety penalty is

$${R}_{u f} = - {{α}_{5} ( \frac{{D}_{u}}{{d}_{u k} [ n ]} )}^{2} ,$$

where α₅ represents a UAV safe distance maintenance coefficient, preferably 0.5 in the embodiment.

To reduce invalid action, an invalid action penalty is Rᵢₐ=−α₆, where α₆ represents a collision penalty value, preferably 1 in the embodiment.

$$A global reward function is R = {R}_{d c} + {R}_{tk} + {R}_{u o} + {R}_{s o} + {R}_{u f} + {R}_{i a} .$$

Specifically, an experimental parameter table of the embodiment is as follows:

| Map size | 300*300*50 |
|---|---|
| Number of ground nodes | 10 |
| Maximum moving speed of the ground | 1 m/s |
| node | |
| Number of aerial nodes | 1 |
| Maximum flight speed of a task UAV | 12 m/s |
| Maximum steering angle of the task | |
| UAV | |
| Flight altitude of the task UAV | 30 m |
| Number of non-cooperative UAVs | 1 |
| Maximum flight speed of other UAVs | 6 m/s |
| Maximum steering angle of other | π/4 |
| UAVs | |
| Maximum task time | 300 s |
| Node transmission power | 0.1 W |
| Threshold of signal-to-noise ratio | −5 dB |

Further, to solve a problem that overestimating the value of action, design of a target Q-value function in the DDQN is as follows:

$$y = \{ \begin{matrix}ℛ , S [ n + 1 ] is final state \\ ℛ + γQ ( S [ n + 1 ] , {argmax}_{a [ n + 1 ]} Q ( S [ n + 1 ] , a [ n + 1 ] , {ξ}_{t} ) ; {ξ}_{t}^{-} ) , S [ n + 1 ]\end{matrix}$$

is not final state where a condition for determining S[n+1] as a final state is: signals of all corresponding nodes with

$${Q}_{k}^{L} [ n + 1 ] \neq {Q}_{max}$$

disappear, or a task execution time T is greater than a maximum task time constraint Tₘₐₓ.

Further, a deep reinforcement learning model is adopted to solve the optimization problem, including the steps I-XII.

In step I, the signal-to-noise ratio threshold γ₀, the maximum task time Tₘₐₓ, and the maximum flight speed vₘₐₓ and the maximum steering angle φₘₐₓ of the UAV are set.

In step II, a replay buffer D and an estimation network ξ are initialized, and a target network ξ⁻ is initialized by copying parameters of the estimation network.

In step III, space of legitimate actions is calculated by vₘₐₓ and φₘₐₓ.

In step IV, an experimental environment is initialized, and all environmental parameters are set to initialization values.

In step V, a learning rate is linearly decayed to improve convergence performance of the model.

In step VI, an environmental information vector S[n] is acquired, and state normalization is performed on S[n] to obtain S′[n].

In step VII, S′[n] is input into the estimation network, an action a[n] is obtained, environment is interacted with the agent, and a reward [symbol] [n] and a new environmental information vector S[n+1] are acquired.

In step VIII, normalization is performed on S[n+1], and a tuple (S′[n], a[n], [symbol] [n], S′[n+1]) is added in the replay buffer D.

In step IX, a sample is taken from D, a gradient is calculated by using a loss function, and network parameters are updated.

In step X, parameters of ξ are copied to ξ⁻ once every Nᵣ updates; and Nᵣ is an artificially set threshold for training iterations of the neural network, preferably 600 in the embodiment.

In step XI, it is determined whether S[n+1] is a final state, if so, proceeding to step 4; otherwise, proceeding to step 5.

In step XII, if the data collection rate and the path planning success rate reach preset expected values, a training loop is stopped, to obtain optimal parameters of neural network; and the optimal parameters are set to initialization values of different parameters in the neural network and a well-trained agent is obtained, in which the expected value of data collection rate is preferably 99%, and the expected value of path planning success rate is preferably 95%.

In S4, the agent is deployed to the UAV, the UAV acquiring real-time environmental data, the agent giving an action instruction for a next moment of the UAV according to the real-time environmental data, and the UAV executing a data collection task according to the action instruction.

Furthermore, FIG. 3 shows a convergence procedure of a proposed algorithm and a comparison algorithm after smoothing treatment. Specifically, the algorithm proposed in the present disclosure is a UAV data collection and obstacle-avoidance trajectory planning algorithm based on the DDQN, and the comparison algorithm is a basic Dueling DQN algorithm. It can be seen that a reward value of the basic Dueling DQN algorithm exhibits persistent severe fluctuations after an initial increase and fails to reach the maximum. In contrast, the algorithm proposed in the present disclosure demonstrates significant performance improvement with smaller fluctuations during convergence, exhibiting superior stability in the presence of dynamic obstacles within a forest fire environment.

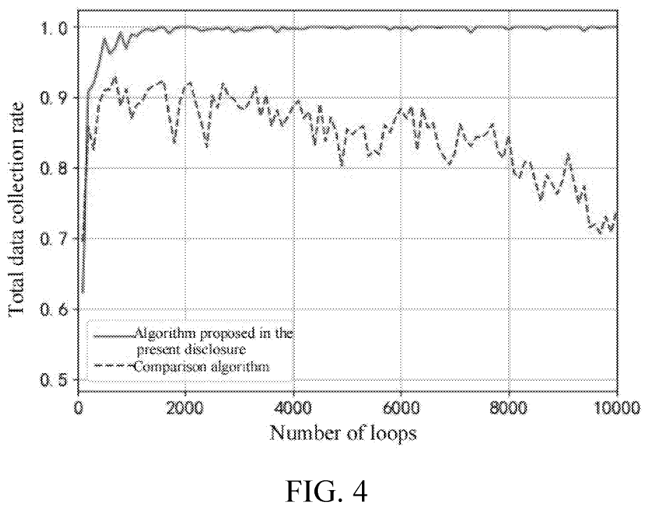

FIG. 4 shows total data collection rates collected by the UAV from all nodes in each task under different algorithms. Affected by environmental factors, fire spread processes, aerial nodes and non-cooperative UAVs, a collection rate of the basic Dueling DQN algorithm hovers around 90% following an initial rise, subsequently declining to approximately 75%. In contrast, the algorithm proposed in the present disclosure attains 100% after an initial ascent phase and remains stable at a level close to 100%, demonstrating the effectiveness in mobile node data collection tasks under the influence of dynamic obstacles.

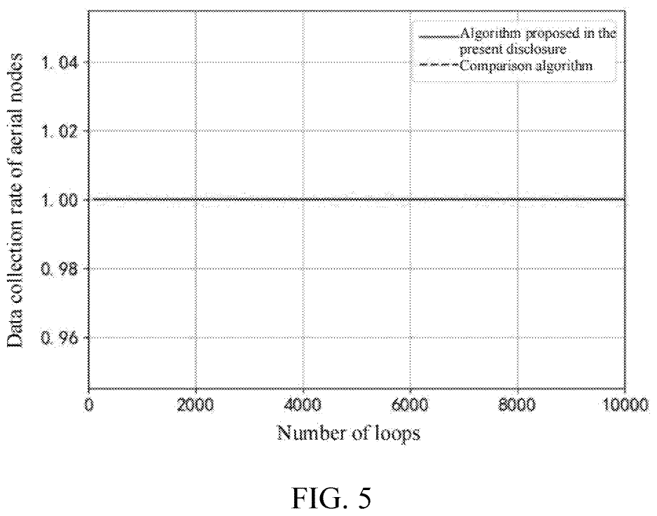

FIG. 5 shows data collection rates collected by the UAV from aerial nodes under different algorithms. It can be seen that due to favorable LoS propagation paths, the task UAV achieves a 100% collection rate across all algorithms. Moreover, 100% data collection from the aerial nodes is already attained by the UAV at the beginning of the training process.

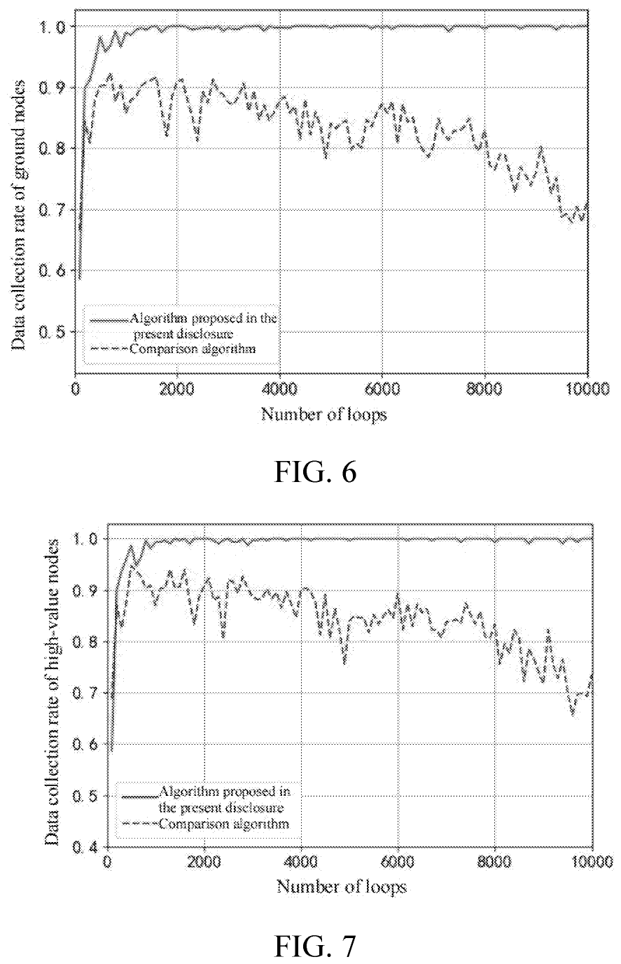

FIG. 6 shows data collection rates of the UAV for ground nodes, including UGVs and firefighters under different algorithms. Compared with the aerial nodes, ground nodes suffer from greater communication channel loss, and the mobility of such nodes requires the task UAV to flexibly adjust its trajectory during data collection. It can be seen that the basic Dueling DQN algorithm exhibits a collection rate hovering around 90% following an initial rise, which subsequently declines to approximately 70%. In contrast, the algorithm proposed in the present disclosure achieves 100% after the initial ascent phase and maintains a level close to 100%.

FIG. 7 shows partial data collection rates of the UAV for high-value nodes under different algorithms. In the figure, data with the top 30% unit data value is defined as high-value node data. It can be seen that the basic Dueling DQN algorithm fluctuates severely around 90% initially before dropping to 70%, whereas the algorithm proposed in the present disclosure converges rapidly to approximately 100%, demonstrating a distinct preference for prioritizing high-value data.

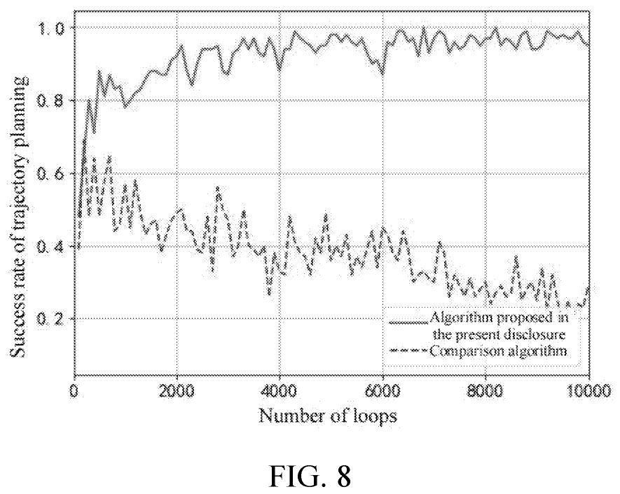

FIG. 8 shows success rates of safety trajectory planning by the UAV under different algorithms. It can be seen that although the same environmental perception method is adopted, under the condition that both static and dynamic obstacles exist in the environment, the basic Dueling DQN algorithm suffers from a continuous decline and severe fluctuations in success rate of trajectory planning after an initial rise, failing to guarantee flight safety. In contrast, the algorithm proposed in the present disclosure shows a steady increase followed by convergence above 95%, demonstrating the adaptability to the complex flight environment of forest fires.

Finally, it is to be noted that the above description merely illustrates some embodiments of the present disclosure. Various changes, modifications, substitutions and alterations to these embodiments may be conceivable to those skilled in the art without departing from the principle and spirit of the present disclosure. The protection scope of the present disclosure is defined by the appended claims and equivalents thereof, and all such changes, modifications, substitutions and alterations are intended to be covered within the protection scope of the present disclosure.

1. An obstacle-avoidance unmanned aerial vehicle (UAV)-based data collection method for mobile nodes in forest fires, comprising the following steps:
step 1, acquiring data of ground mobile nodes and data of UAV nodes, and establishing a system model according to the data of the ground mobile nodes and the data of the UAV nodes, wherein the ground mobile nodes comprise unmanned ground vehicle (UGV) nodes and firefighter nodes, and the system model comprises a system architecture, a fire area model, a mobile node model and a data collection task model, the system architecture being composed of K wireless sensor nodes, and the wireless sensor nodes comprising K₁ UAV nodes, K₂ UGV nodes and K₃ firefighter nodes, K=K₁+K₂+K₃; the fire area model describing a process of forest fire spread by adopting a cellular automaton; and the mobile node model calculating a unit data value of each node according to the data of the ground mobile nodes and the data of the UAV nodes;
step 2, constructing an optimization problem according to the system model, the unit data value being used for constructing the optimization problem, and a formula of the unit data value being:
$${p}_{k} [ n ] = β ( 1 - {\vert {φ}_{k}^{f} [ n ] - \frac{π}{2} \vert}^{2} ) + γ$$
where pₖ[n] represents a unit data value of a node k in an n-th time slot, β represents a node motion trend attention coefficient,
$${φ}_{k}^{f} [ n ]$$
represents an indicator of a relative position change between the node and the forest fire, and y represents a firefighter life safety coefficient;
step 3, solving the optimization problem, and obtaining an agent for planning an obstacle-avoidance path according to a result of the solving; and
step 4, deploying the agent on a UAV, wherein the UAV acquires real-time environmental data, the agent gives an action instruction for a next moment to the UAV according to the real-time environmental data, and the UAV executes a data collection task according to the action instruction.

2. The obstacle-avoidance UAV-based data collection method for mobile nodes in forest fires of claim 1, wherein constraint conditions of the optimization problem comprise: a UAV flight speed performance constraint, a UAV steering performance constraint, an environmental wind uncertainty constraint, an obstacle avoidance constraint, a safety distance constraint between UAVs, a scheduling constraint, a data transmission constraint, and a task time constraint.

3. The obstacle-avoidance UAV-based data collection method for mobile nodes in forest fires of claim 1, wherein a double deep Q-network (DDQN) reinforcement learning model is adopted when solving the optimization problem.
